(19) United States
(12) Patent Application Publication
(10) Pub. No.: US 2014/0310764 A1
(43) Pub. Date: Oct. 16, 2014

(54) METHOD AND APPARATUS FOR PROVIDING USER AUTHENTICATION AND IDENTIFICATION BASED ON GESTURES

(71) Applicants: Peter Tippett, Great Falls, VA (US); Steven T. Archer, Dallas, TX (US); Paul V. Hubner, McKinney, TX (US); Paul A. Donfried, Richmond, MA (US); Scott N. Kern, Salt Lake City, UT (US)

(72) Inventors: Peter Tippett, Great Falls, VA (US); Steven T. Archer, Dallas, TX (US); Paul V. Hubner, McKinney, TX (US); Paul A. Donfried, Richmond, MA (US); Scott N. Kern, Salt Lake City, UT (US)

(73) Assignee: Verizon Patent and Licensing Inc., Basking Ridge, NJ (US)

(21) Appl. No.: 13/861,771

(22) Filed: Apr. 12, 2013

(51) Int. Cl. G06F 21/31

(52) U.S. Cl. CPC G06F 21/31
USPC 726/1; 726/7

(57) ABSTRACT

An approach is provided for authenticating and/or identifying a user through gestures. A plurality of media data sets of a user performing a sequence of gestures are captured. The media data sets are analyzed to determine the sequence of gestures. Authentication of the user is performed based on the sequence of gestures.

### RELATED APPLICATIONS

This application claims priority to U.S. Provisional Application Ser. No. 61/732,692, filed Dec. 3, 2012; the entirety of which is incorporated herein by reference.

### BACKGROUND INFORMATION

Given the reliance on computers, computing devices (e.g., cellular telephones, laptop computers, personal digital assistants, and the like), and automated systems (e.g., automated teller machines, kiosks, etc.) to conduct secure transactions and/or access private data, user authentication is critical. Traditional approaches to user authentication involve utilizing user identification and passwords, which comprise alphanumeric characters. Unfortunately, text-based passwords are susceptible to detection by on-lookers if the password is overly simplistic or “weak.” It is noted, however, that “strong” passwords—i.e., passwords that are difficult to reproduce by unauthorized users—are also difficult for the users who created them to remember. Consequently, users generally do not create such “strong” passwords. Moreover, it not uncommon that users employ only a limited number of passwords for the many applications requiring passwords. In short, authentication mechanisms that rely on traditional text-based passwords can pose significant security risks.

Therefore, there is a need for an approach that can generate passwords that are strong, but are relatively easy to recall and input.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of authenticating using user gestures, according to an exemplary embodiment;

FIG. 2 is a flowchart of a process for authenticating and/or identifying a user through gestures, according to an exemplary embodiment;

FIG. 3 is a diagram of an information appliance device configured to provide authentication and/or identification through gestures, according to an exemplary embodiment;

FIGS. 4A and 4B are flowcharts of processes for providing authentication services, according to an exemplary embodiment;

FIGS. 5A-5C are graphical user interfaces (GUIs) for capturing sequences of gestures for authentication and/or identification, according to various embodiments;

FIGS. 5D-5E show facial videos of users corresponding to the same facial gesture combination for authentication and/or identification, according to various embodiments;

FIG. 6 shows a video corresponding to a sequence of body movement gestures for authentication and/or identification, according to one embodiment;

FIGS. 7A and 7B illustrate frequency charts of two users corresponding to the same sound/voice gesture combination for authentication and/or identification, according to various embodiments;

FIG. 8 is a graphical user interface for capturing sequences of gestures for authentication and/or identification, according to an exemplary embodiment;

FIG. 9 is a diagram of a mobile device configured to authenticate and/or identify a user, according to an exemplary embodiment;

FIG. 10 is a diagram of a computer system that can be used to implement various exemplary embodiments; and

FIG. 11 is a diagram of a chip set that can be used to implement various exemplary embodiments.

### DESCRIPTION OF THE PREFERRED EMBODIMENT

A preferred apparatus, method, and software for authenticating based on gestures are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

As used herein, the term “gesture” refers to any form of non-verbal communication in which visible bodily actions communicate particular messages, either in place of speech or together and in parallel with words. “Verbal communication” may refer to words that are used by humans as well as the manner the words are used. Gestures can include movement of the hands, face, eyes, lips, nose, arms, shoulders, legs, feet, hip, or other parts of the body. As used herein, the term “audio communication” refers to any form of non-verbal communication generated via human gestures. “Audio communication” includes “vocal communication” and sound generated via human bodily actions, such as hand clapping, foot tapping, etc. “Vocal communication” is delivered via human voice tone, volume, pitch, expression, pronunciation, pauses, accents, emphasis; and of course, periods of silence.

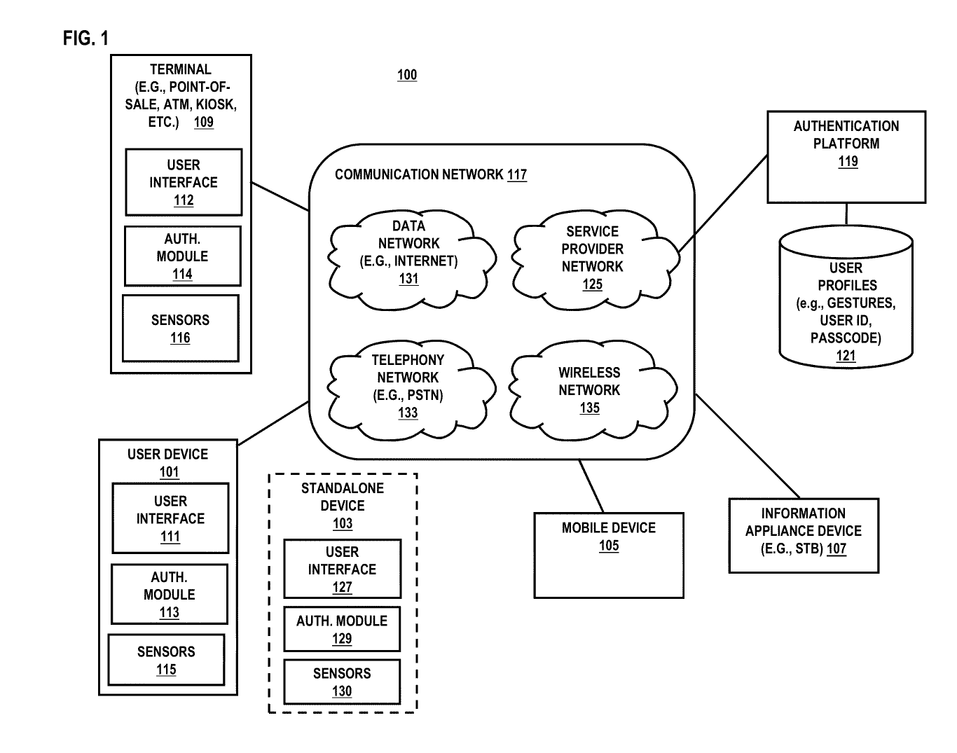

FIG. 1 is a diagram of a system capable of authenticating using user gestures, according to an exemplary embodiment. Generally, multifactor authentication provides a stronger level of authentication than single factor authentication. For example, requesting multiple types or numbers of authentication credentials can ensure a higher level of authentication than requesting a single set of authentication credentials. In other words, by increasing the number of authentication factors, the authentication strength can be greatly improved.

The authentication factors may include the static features of each gesture (e.g., facial features of a user), the occurring process of each gesture (e.g., timing, ranging, etc.), the transitions/interfaces in-between gestures (e.g., an occurring order of the gestures, timing and ranging of overlaps or interval in-between gestures), etc. Some or all of the authentication factors can be recorded as a feature vector, a gesture vector, a gesture transition vector, or a combination thereof, in an authentication database for user authentication and/or identification. Each of such entry in the database constitutes an authentication signature of the user. The system deploys the vectors based upon the context of the user authentication and/or identification, access policies, etc.

By way of example, a feature vector includes shapes/sizes/positions of eyes, nose, mouth, face, etc. of one user; a gesture vector includes shapes/sizes/positions/timing/ranging of the mouth movements when the user smiles; and a gesture transition vector including timing and ranging between a smiling gesture and an eye blinking gesture. After recording the authentication signatures, the system can use one or more of the authentication signatures for user authentication and/or identification. By way of example, a mother can use the system to identify which of the triplet babies by the ranges and lengths of their giggling or crying sound. As another example, after putting the triplet babies in a bath tub, the mother can use the system to identify which baby has been bathed by the ranges and lengths of their smiles and blinking their eyes.

As a result, a system 100 of FIG. 1 introduces a capability to add new factor instances for image/sound/vocal recognition based authentication and/or identification systems. Information relating to gestures reflected through image, sound, vocal, or a combination therefor, may constitute one or more media data sets. The system 100 provides for increased authentication factors by combining image recognition (e.g., facial recognition) with gesture recognition (e.g., recognition of facial gestures), and/or sound/vocal recognition. Visual gesture recognition can be conducted with techniques such as computer vision, image processing, etc. By way of example, computer vision involves capturing gestures or more general human pose and movements via sensors (e.g., cameras) connected to a computing device (e.g., tablet, smartphone, laptop, etc.). Although various embodiments are discussed with respect to facial gestures, it is contemplated that the various embodiments described herein are applicable to any type of user gestures (e.g., body gestures, hand gestures, sound/vocal gestures, and the like).

In one embodiment, a user can execute an authentication maneuver including multiple authentication factors such as “closing one eye and raising one eyebrow.” The system 100 (specifically, platform 119 in combination with the devices 101, 103, or 109) then captures dynamic and multiple images (e.g., images or video) to provide both a more authoritative authentication/identification of a user as well as provide a continuum to update identity marker criteria. For example, gestures (e.g., facial gestures) can be recognized, identified, and linked to key actions such as system authentication. In one embodiment, a complex grouping of gestures can be created either in series (e.g., wink, nod, smile, etc.), in parallel (e.g., smile with left eye closed), or both. This, for instance, ensures that users have more freedom to define unique gestures. In this way, only a specific identified user may perform a set of gestures and be recognized to have caused the gestures.

By way of illustration, typical facial gestures include, but are not limited to: a wink, blink, smile, frown, nod, look left, right, down, up, roll eyes, etc. Other facial gestures include movement of the eyebrows, cheeks, chin, ears, hair, and other expressions or combinations of facial components. As discussed above, non-facial gestures may also be used. For example, movement of the torso, limbs, fingers, etc. In one embodiment, any user gesture capable of being captured can be recorded or captured by the system 100 for processing.

For the purpose of illustration, the system 100 includes various devices 101-109, each of which is configured with respective cameras or other imaging devices to provide user authentication/identification based on unique gestures (e.g., facial gestures and optionally in conjunction with image recognition or other authentication credentials). Such user gestures can serve as authentication credentials to verify the identity of or otherwise authenticate the user.

Generally, user gestures are results of user habits, preferences, etc. Such user gesture data may be stored with user information. Typical user information elements include a user identifier (e.g., telephone number), nationality, age, language preferences, interest areas, user device model, login credentials (to access the listed information resources of external links), etc.

It is contemplated that the user can define any number of authentication maneuver elements (e.g., whistling, jumping, closing one eye, etc.) and context tokens. The context tokens associated with a person may be a birthday, health, moods, clothes, etc. of the person. The context tokens associated with an activity element may be a time, location, equipment, materials, etc. of the activity. The context tokens associated with an object of interest may be a color, size, price, position, quality, quantity, etc. of the object. In addition or alternatively, the system decides what elements or tokens to represent a user gesture authentication maneuver. By way of example a sequence of gestures including “wearing a black leather glove and placing a key on the palm” may be selected.

In one embodiment, the user gesture data is automatically recorded and/or retrieved by the platform 119 from the backend data and/or external information sources, for example, in a vector format. In another embodiment, the user gesture data is recorded at the user device based upon user personal data, online interactions and related activities with respect to a specific authentication maneuver.

In one embodiment, the user gesture data can be used for authentication and/or identification, whereby one or more actions may be initiated based upon results of the authentication and/or identification. The actions may be granting access to one or more resources, reporting failed authentication and/or identification, taking actions against illegal access attempts, etc.

In this example, user device 101 includes a user interface 111, which in one embodiment, is a graphical user interface (GUI) that is presented on a display (not shown) on the device 101 for capturing gestures via the camera. As shown, an authentication module 113 can reside within the user device 101 to verify the series of user gestures with a stored sequence or pattern of gestures designated for the particular user. In contrast, traditional passwords (that are utilized for login password for logging into a system) are based on entering alphanumeric characters using a keyboard. In one embodiment, the approach of system 100 can authenticate without using text (which also means, without a keyboard/keypad), thereby allowing greater deployment, particularly with devices that do not possess a sufficiently large form factor to accommodate a keyboard.

By way of example, the user device 101 can be any type of computing device including a cellular telephone, smart phone, a laptop computer, a desktop computer, a tablet, a web-appliance, a personal digital assistant (PDA), and etc. Also, the approach for authenticating users, as described herein, can be applied to other devices, e.g., terminal 109, which can include a point-of-sale terminal, an automated teller machine, a kiosk, etc. In this example, user device 101 has a user interface 111, an authentication module 113. and sensors (e.g., camera) 115 that permit users to enter a sequence of gestures, whereby the user device 101 can transport the sequence over a communication network 117 for user verification by an authentication platform 119.

In one embodiment, one or more of the sensors 115 of user device 101 determines, for instance, the local context of the user device 101 and any user thereof, such as user physiological state and/or conditions, a local time, geographic position from a positioning system, ambient temperature, pressures, sound and light, etc. By way of examples, various physiological authentication maneuver elements includes eye blink, head movement, facial expression, kicking, etc., while operating under a range of surrounding conditions. A range and a scale may be defined for each element and/or movement. By way of example, a smile may range as small, medium and big for one user who smiles often and open in one scale, and in another scale for a different user who has a smaller month. The sensor data can be use by the authentication platform 119 to authenticate the user.

The user device 101 and/or the sensors 115 are used to determine the user's movements, by determining movements of the reference objects within the one or more sequences of images, wherein the movements of the reference objects are attributable to one or more physical movements of the user. In one embodiment, the user device 101 has a built-in accelerometer for detecting motions. The motion data extracted from the images is used for authenticating the user. In one embodiment, the sensors 115 collect motion signals by a Global Positioning System (GPS) device, an accelerometer, a gyroscope, a compass, other motion sensors, or combinations thereof. The images and the motion features can be used independently or in conjunction with sound/vocal features to authenticate the user. Available sensor data such as location information, compass bearing, etc. are stored as metadata, for example, in an image exchangeable image file format (EXIF).

The sensors 115 can be independent devices or incorporated into the user device 101. The sensors 115 may include an accelerometer, a gyroscope, a compass, a GPS device, microphones, touch screens, light sensors, or combinations thereof. The sensors 115 can be a head/ear phone, a wrist device, a pointing device, or a head mounted display. By way of example, the user wears a head mounted display with sensors to determine the position, the orientation and movement of the user's head. The user can wear a device around a belt, a wrist, a knee, an angle, etc., to determine the position, the orientation and movement of the user's hip, hand, leg, foot, etc. The device gives an indication of the direction and movement of a subject of interest in a 3D space.

The authentication platform 119 maintains a user profile database 121 that is configured to store user-specific gestures along with the user identification (ID) of subscribers to the authentication service, according to one embodiment. Users may establish one or more sub-profiles including reference gestures as well as other authentication credentials such as usernames, passwords, codes, personal identification numbers (PINs), and etc. relating to user authentication as well as user accounts and preferences. While user profiles repository 121 is depicted as an extension of service provider network 125, it is contemplated that user profiles repository 121 can be integrated into, collocated at, or otherwise in communication with any of the components or facilities of system 100.

Moreover, database 121 may be maintained by a service provider of the authentication platform 119 or may be maintained by any suitable third-party. It is contemplated that the physical implementation of database 121 may take on many forms, including, for example, portions of existing repositories of a service provider, new repositories of a service provider, third-party repositories, and/or shared-repositories. As such, database 121 may be configured for communication over system 100 through any suitable messaging protocol, such as lightweight directory access protocol (LDAP), extensible markup language (XML), open database connectivity (ODBC), structured query language (SQL), and the like, as well as combinations thereof. In those instances when database 121 is provided in distributed fashions, information and content available via database 121 may be located utilizing any suitable querying technique, such as electronic number matching, distributed universal number discovery (DUNDi), uniform resource identifiers (URI), etc.

In one embodiment, terminal 109 can be implemented to include an authentication module 114 and one or more sensors 116, similar to those of the user device 101. Other devices can include a mobile device 105, or any information appliance device 107 with an authentication module and one or more sensors (e.g., a set-top box, a personal digital assistant, etc.). Moreover, the authentication approach can be deployed within a standalone device 103; as such, the device 103 utilizes a user interface 127 that operates with an authentication module 129 and sensor(s) 130 to permit access to the resources of the device 103, for instance. By way of example, the standalone device 103 can include an automated teller machine (ATM), a kiosk, a point-of-sales (POS) terminal, a vending machine, etc.

Communication network 117 may include one or more networks, such as data network 131, service provider network 125, telephony network 133, and/or wireless network 135. As seen in FIG. 1, service provider network 125 enables terminal 109 to access the authentication services of platform 119 via communication network 117, which may comprise any suitable wireline and/or wireless network. For example, telephony network 133 may include a circuit-switched network, such as the public switched telephone network (PSTN), an integrated services digital network (ISDN), a private branch exchange (PBX), or other similar networks. Wireless network 135 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), third generation (3G), fourth generation (4G) Long Term Evolution (LTE), etc., as well as any other suitable wireless medium, e.g., microwave access (WiMAX), wireless fidelity (WiFi), satellite, and the like. Meanwhile, data network 131 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 125 and 131-135 may be completely or partially contained within one another, or may embody one or more of the aforementioned infrastructures. For instance, service provider network 125 may embody circuit-switched and/or packet-switched networks that include facilities to provide for transport of circuit-switched and/or packet-based communications. It is further contemplated that networks 125 and 131-135 may include components and facilities to provide for signaling and/or bearer communications between the various components or facilities of system 100. In this manner, networks 125 and 131-135 may embody or include portions of a signaling system 7 (SS7) network, or other suitable infrastructure to support control and signaling functions. While specific reference will be made hereto, it is contemplated that system 100 may embody many forms and include multiple and/or alternative components and facilities.

It is observed that the described devices 101-109 can store sensitive information as well as enable conducting sensitive transactions, and thus, require at minimum the ability to authenticate the user's access to these resources. As mentioned, traditional passwords are text-based and can readily compromise security as most users tend to utilize “weak” passwords because they are easy to remember.

Therefore, the approach of system 100, according to certain exemplary embodiments, stems from the recognition that non-text based methods with multiple authentication factors (e.g., both image recognition and gesture recognition) are more difficult to replicate, and thus, are more likely to produce “strong” passwords with relatively more ease. That is, the user may remember a sequence of gestures more than a complex sequence of alphanumeric characters.

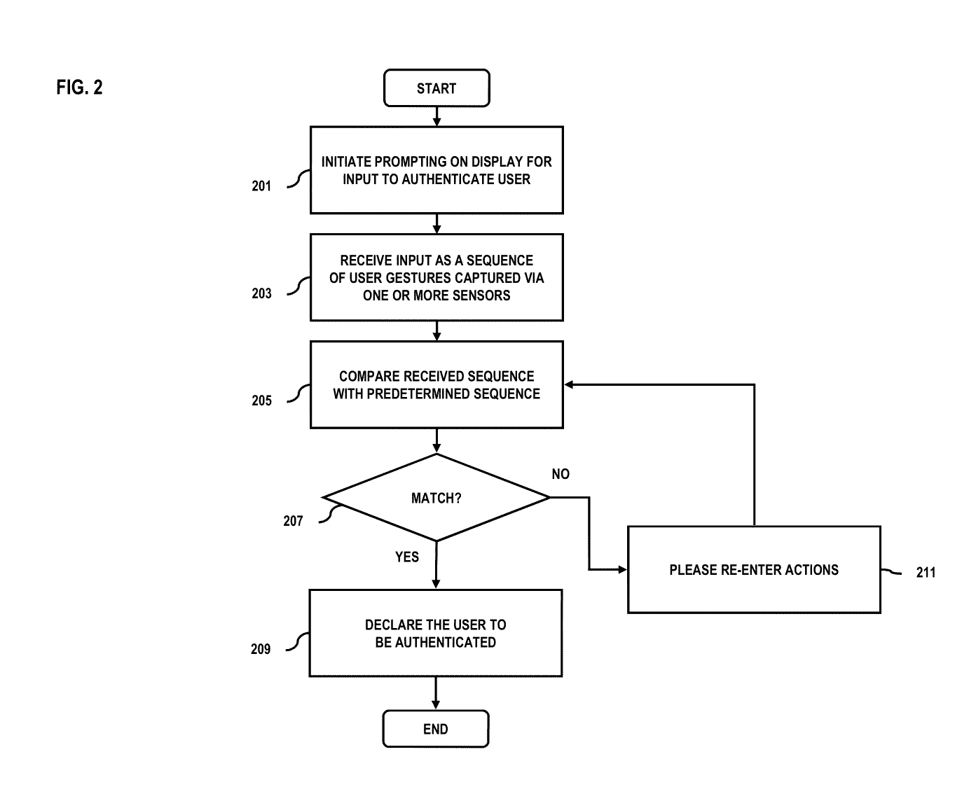

FIG. 2 is a flowchart of a process for authenticating and/or identifying a user through gestures, according to an exemplary embodiment. By way of example, this authentication process is explained with respect to user device 101. In step 201, a prompt is provided on the display of the user device 101 indicating to the user that gesture authentication is needed. For example, the request may be prompted when a user attempts to log into a system. On presenting the prompt, the user device 101 can activate its camera (e.g., a front-facing camera) to begin capturing images of the user. The user device 101 then receives the authentication input as a sequence of images or video of the user making one or more gestures (e.g., facial gestures) (step 203). For example, the user can look into the camera and make one or more gestures in series, in parallel, or both. In one embodiment, the gestures may have been previously stored as a “passcode” for the user. In other embodiments, the user device 101 may request that the user perform a set of gestures (e.g., smile and then wink).

In one embodiment, as a user presents his or her face to the camera on the user device 101 to access a resource, the system 100 (e.g., the authentication platform 119) begins capturing multiple images (e.g., video) for analysis. In one embodiment, image markers are calculated locally at the user device 101 and sent to the authentication platform 119 for comparison or analysis. By way of example, image markers for facial gestures include, but are not limited to: e.g., interpupilary distance, eye-eye-mouth geometries, etc. It is contemplated that the image markers can be based on any facial or user feature identified in the images. As noted above, the user may submit a sequence of gestures that only the user knows or that the user is prompted to enter by the system.

Next, in step 205, the input sequence of gestures is compared with a predetermined sequence for the particular user. It is noted that this predetermined sequence could have been previously created using the user device 101, or alternatively created using another device, e.g., the user's mobile phone or set-top box (which may transfer the predetermined sequence to the authentication module 113 of the user device 101 using a wireless or wired connection). If the process determines that there is a match, per step 207, then the process declares the user to be an authorized user (step 209). In one embodiment, the system 100 observes or analyzes the geometries of the gestures to determine whether the geometries match to a predetermined degree. Otherwise, the process can request that the user re-enter the passcode by performing the sequence of gestures again (step 211). According to one embodiment, the process may only allow the user to enter the passcode unsuccessfully after a predetermined number of attempts. For example, the process may lock the user out after three unsuccessful tries.

As mentioned, the above process has applicability in a number of applications that require authentication of the user. For example, this non-text based authentication process can be incorporated into the operating system of a computer. Also, this process can be utilized at point-of-sale terminals for users to conduct commercial transactions. According to another embodiment, user authentication can be deployed within an information appliance device (e.g., a set-top box) to, for example, verify the user's identity for purchasing on-demand content.

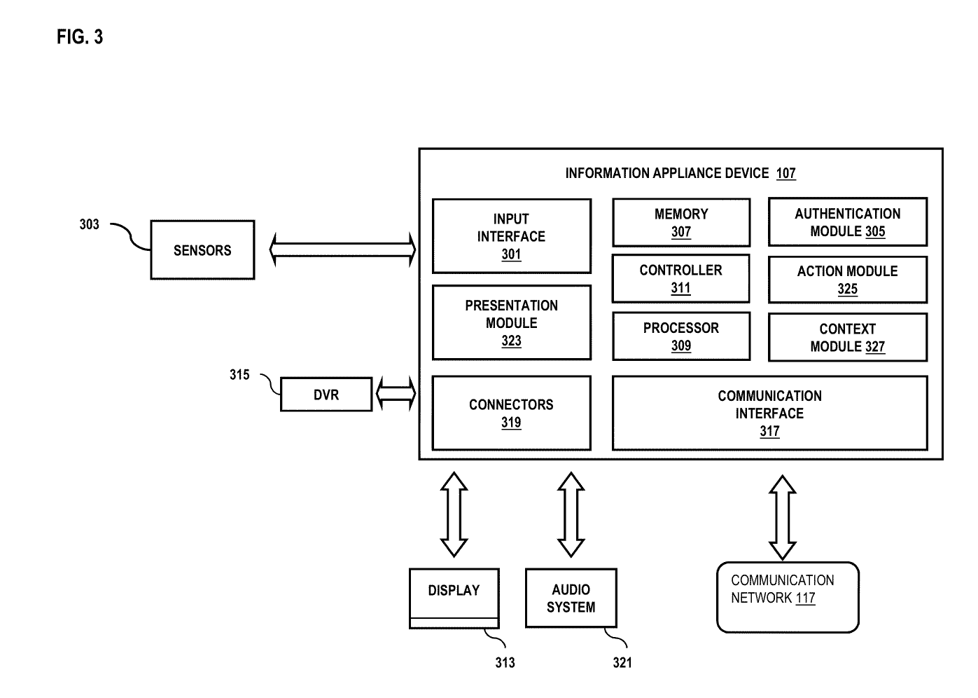

FIG. 3 is a diagram of an information appliance device configured to provide authentication and/or identification through gestures, according to an exemplary embodiment. The information appliance device 107 may comprise any suitable technology to receive user profile information and associated gesture-based authentication credentials from the platform 119. In this example, the information appliance device 107 includes an input interface 301 that can receive gesture input from the user via one or more sensors (e.g., a camera device, a microphone, etc.) 303. Also, an authentication module 305 resides within the information appliance device 107 to coordinate with the authentication process with the authentication platform 119. The information appliance device 107 also includes a memory 307 for storing the captured media data sets (e.g., images, audio data, etc.) of the user for gesture analysis (e.g., geometries of the gestures, frequency charts of the gestures, etc.), as well as instructions that are performed by a processor 309. The sequence of gestures may include body movement gestures, voice gesture, sound gestures, or a combination thereof.

In some embodiments, either the authentication module 305, or an additional module of the information appliance device 107, or the authentication platform 119, or an additional module of the authentication platform 119 separately or jointly performs dynamic gesture recognition. By way of example, the authentication module 305 uses a camera to track the motions and interpret these in terms of actual meaningful gestures, via processing the visual information from the camera, identifying the key regions and elements (such as lips, eyebrows, etc.), transforming the 2D information into 3D spatial data, applying the 3D spatial data to a calibrated model (e.g., mouth, hand, etc.) using inverse projection matrices and inverse kinematics, simplifying this model into gesture curvature information fed to, for example, a hidden Markov model. The model can be used to identify and differentiate between different gestures.

In another embodiment, the platform 119 adopts the model to define each gesture as an n-dimensional vector that combines shape information, one or more movement trajectories of one or more body parts as well as the relevant timing information. The movement trajectories are recorded with associated spatial transformation parameters, such as translation, rotation, scaling/depth variations etc. of one or more body parts. The platform 119 can also establishes a gesture database and determine error tolerance, so as to reach desired recognition accuracy.

In other embodiments, different forms of gestures are deployed together to strengthen the accuracy of the authentication and/or identification. By way of example, the platform 119 measures a person's physiological state and/or conditions (e.g., a heart rate) when performing various bodily movement gestures (e.g., jumping). The platform 119 then utilizes both sets of gesture data for authentication and/or identification. As another example, the platform 119 collects sounds generated by the user when performing various bodily movement gestures (e.g., tabbing a table with one finger), and then uses both sets of gesture data for authentication and/or identification.

In other embodiments, the platform 119 determines one or more transitions of the gestures including, at least in part, one or more sound transitions, one or more vocal transitions, one or more visual transitions, or a combination thereof. The transitions of the gestures can be, e.g., 1 to 20 seconds long (e.g., as enacted by the user). By way of example, a neutral facial transition of 10 seconds exists in-between blinking both eyes and turning the head to the right. As another example, a vocal transition of saying “well” exists in-between “coughing for 10 seconds” and “clearing the throat.”

In another embodiment, the platform 119 uses the transitions of the gestures independently or in conjunction with the gestures for authentication and/or identification. By way of example, the authentication maneuver is “humming and/or whistling two folk songs.” A user may select any two folk songs of interest and any style of transition in-between the two songs. The platform 119 records timing, duration, tempo, beat, bar, key, rhythm, pitch chords, and/or the dominant melody and bass line, etc. of the two folk songs and the transition for authentication and/or identification. Continuing with the same example, when the user decides only to hum notes of two folk songs, the platform 119 analyzes monophonic lines (e.g., bass, melody etc.) thereof. When the user decides to hum and whistle two folk songs simultaneously, the platform 119 analyzes chord changes of multiple auditory signals (i.e., humming and whistling), in addition to monophonic lines.

For example, known methods of sound/voice analysis may be used to analyze the melody, bass line, and/or chords in sound/voice. Such methods may be based on, for example, using frame-wise pitch-salience estimates as features. These features may be processed by an acoustic model for note events and musicological modeling of note transitions. The musicological model may involve key estimation and note bigrams which determine probabilities for transitions between target notes. A transcription of a melody or a bass line may be obtained using Viterbi search via the acoustic model. Furthermore, known methods for beat, tempo, and downbeat analysis may be used to determine rhythmic aspects of sound/voice. Such methods may be based on, for example, measuring the degree of sound change or accent as a function of time from the sound signal, and finding the most common or strongest periodicity from the accent signal to determine the sound tempo.

In the above-mentioned embodiments, the system analyzes the plurality of media data sets to determine one or more features of each of the gestures, one or more features of the sequence of gestures, or a combination thereof. The platform 119 then recognizes the user based on the features of each of the gestures, the features of the sequence of gestures, or a combination thereof. The features include content information, timing information, ranging information, or a combination thereof, and the authenticating of the user is further based on the recognition. The timing information includes a start time, a stop time, an overlapping period, an interval, or a combination thereof, of the sequence of gestures. In one embodiment, the system compares the features associated with the sequence of gestures against features of one or more pre-stored sequences. The recognition of the user is based on the comparison.

Further, the information appliance device 107 (e.g., a STB) may also include suitable technology to receive one or more content streams from a media source (not shown). The information appliance device 107 may comprise computing hardware and include additional components configured to provide specialized services related to the generation, modification, transmission, reception, and display of user gestures, profiles, passcodes, control commands, and/or content (e.g., user profile modification capabilities, conditional access functions, tuning functions, gaming functions, presentation functions, multiple network interfaces, AV signal ports, etc.). Alternatively, the functions and operations of the information appliance device 107 may be governed by a controller 311 that interacts with each of the information appliance device components to configure and modify user profiles including the passcodes.

As such, the information appliance device 107 may be configured to process data streams to be presented on (or at) a display 313. Presentation of the content may be in response to a command received from input interface 301 and include: displaying, recording, playing, rewinding, forwarding, toggling, selecting, zooming, or any other processing technique that enables users to select customized content instances from a menu of options and/or experience content.

The information appliance device 107 may also interact with a digital video recorder (DVR) 315, to store received content that can be manipulated by a user at a later point in time. In various embodiments, DVR 315 may be network-based, e.g., included as a part of the service provider network 125, collocated at a subscriber site having connectivity to the information appliance device 107, and/or integrated into the information appliance device 107.

Display 313 may present menus and associated content provided via the information appliance device 107 to a user. In alternative embodiments, the information appliance device 107 may be configured to communicate with a number of additional peripheral devices, including: PCs, laptops, PDAs, cellular phones, monitors, mobile devices, handheld devices, as well as any other equivalent technology capable of presenting modified content to a user, such as those computing, telephony, and mobile apparatuses described with respect to FIG. 1.

Communication interface 317 may be configured to receive user profile information from the authentication platform 119. In particular embodiments, communication interface 317 can be configured to receive content and applications (e.g., online games) from an external server (not shown). As such, communication interface 317 may optionally include single or multiple port interfaces. For example, the information appliance device 107 may establish a broadband connection to multiple sources transmitting data to the information appliance device 107 via a single port, whereas in alternative embodiments, multiple ports may be assigned to the one or more sources. In still other embodiments, communication interface 317 may receive and/or transmit user profile information (including modified content menu options, and/or modified content scheduling data).

According to various embodiments, the information appliance device 107 may also include inputs/outputs (e.g., connectors 319) to display 313 and DVR 315, as well as an audio system 321. In particular, audio system 321 may comprise a conventional AV receiver capable of monaural or stereo sound, as well as multichannel surround sound. Audio system 321 may include speakers, ear buds, headphones, or any other suitable component configured for personal or public dissemination. As such, the information appliance device 107 (e.g., a STB), display 313, DVR 315, and audio system 321, for example, may support high resolution audio and/or video streams, such as high definition television (HDTV) or digital theater systems high definition (DTS-HD) audio. Thus, the information appliance device 107 may be configured to encapsulate data into a proper format with required credentials before transmitting onto one or more of the networks of FIG. 1, and de-encapsulate incoming traffic to dispatch data to display 313 and/or audio system 321.

In an exemplary embodiment, display 313 and/or audio system 321 may be configured with internet protocol (IP) capability (i.e., include an IP stack, or otherwise made network addressable), such that the functions of the information appliance device 107 may be assumed by display 313 and/or audio system 321 and controlled, in part, by content manager command(s). In this manner, an IP ready, HDTV display or DTS-HD audio system may be directly connected to one or more service provider networks 125, packet-based networks 131, and/or telephony networks 133. Although the information appliance device 107, display 313, DVR 315, and audio system 321 are shown separately, it is contemplated that these components may be integrated into a single component, or other combination of components.

An authentication module 305, in addition to supporting the described gesture-based authentication scheme, may be provided at the information appliance device 107 to initiate or respond to authentication schemes of, for instance, service provider network 125 or various other content providers, e.g., broadcast television systems, third-party content provider systems (not shown). Authentication module 305 may provide sufficient authentication information, e.g., gestures, a user name and passcode, a key access number, a unique machine identifier (e.g., GUID or MAC address), and the like, as well as combinations thereof, to a corresponding network interface for establishing connectivity. Further, authentication information may be stored locally at memory 307, in a repository (not shown) connected to the information appliance device 107, or at a remote repository, e.g., database 121 of FIG. 1.

A presentation module 323 may be configured to receive data streams and AV feeds and/or control commands (including user actions), and output a result via one or more connectors 319 to display 313 and/or audio system 321.

Connector(s) 319 may provide various physical interfaces to display 313, audio system 321, and the peripheral apparatuses; the physical interfaces including, for example, RJ45, RJ11, high definition multimedia interface (HDMI), optical, coax, FireWire, wireless, and universal serial bus (USB), or any other suitable connector. The presentation module 323 may also interact with input interface 301 for configuring (e.g., modifying) user profiles, as well as determining particular content instances that a user desires to experience. In an exemplary embodiment, the input interface 301 may provide an interface to a remote control (or other access device having control capability, such as a joystick, video game controller, or an end terminal, e.g., a PC, wireless device, mobile phone, etc.) that provides a user with the ability to readily manipulate and dynamically modify parameters affecting user profile information and/or a multimedia experience. Such parameters can include the information appliance device 107 configuration data, such as parental controls, available channel information, favorite channels, program recording settings, viewing history, or loaded software, as well as other suitable parameters.

An action module 325 may be configured to determine one or more actions to take based upon the authenticating results from the authentication module 305. Such actions may be determined based upon resource access policies (e.g., privacy policy, security policy, etc.), for granting access to one or more resources, and one or more action commends may be output via one or more connectors 319 to display 313 and/or audio system 321, or via the communication interface 317 and the communication network 117 to external entities. The resource may be an electronic object (e.g., data, a database, a software application, a website, an account, a game, a virtual location, etc.), or a real-life object (e.g., a safe, a mail box, a deposit box, a locker, a device, a machine, a piece of equipment, etc.). In one embodiment, the policies may be initially selected by a user (e.g., a bank manager) at a user device (e.g., a secured computer) to ensure that collected data will only be utilized in certain ways or for particular purposes (e.g., authorized user access to the user's account information).

In one embodiment, the policy characteristics may include the access request context (e.g., data type, requesting time, requesting frequency, etc.), whether the contexts are permitted by the respective policies, the details of a potential/actual validation of the access requests, etc. By way of example, the data type may be a name, address, date of birth, marital status, contact information, ID issue and expiry date, financial records, credit information, medical history, travel location, interests in acquiring goods and services, etc., while the policies may define how data may be collected, stored, and released/shared (which may be on a per data type basis).

By way of example, with respect to a banking use case involving an attempted robbery, the security policy for a bank safe may include authenticating the bank manager with an authenticating maneuver of “closing one eye and raising one eyebrow” to signal unauthorized access, yet permit opening of the safe as to not alert robbers of any uncooperative behavior on part of the manager. That is, the safe can be opened, while the platform 119 may automatically inform the police of the illegal access. In this case, even if the bank manager is forced to enact the authentication maneuver and the safe appears to be open, the authorities are notified of the potential robbery.

In the above-mentioned embodiments, the platform 119 determines one or more access policies for at least one resource, applies one or more of the access policies based, at least in part, upon the authenticating of the user, and causes, at least in part, operation of at least one action with respect to the at least one resource based upon the applied one or more access policies.

A context module 327 may be configured to determine context and/or context tokens of the authenticating of the user. The user context includes context characteristics/data of a user and/or the user device, such as a date, time, location, current activity, weather, a history of activities, etc. associated with the user, and optionally user preferences. The context module 327 selects among the features of each of the gestures, the features of the sequence of gestures, or a combination thereof for recognizing the user, based, at least in part, on the context and/or context tokens of the authenticating of the user, the applied one or more access policies, or a combination thereof. As mentioned, the context tokens associated with a person may be a birthday, health, moods, clothes, etc. of the person. The context tokens associated with an activity element may be a time, location, equipment, materials, etc. of the activity. The context tokens associated with an object of interest may be a color, size, price, position, quality, quantity, etc. of the object.

According to certain embodiments, the camera device 303 can interact with the display 313 to present passcodes as a series of user gestures. Alternatively, a remote control device can provide remote control gestural sensing via inertial sensors for providing gesture inputs.

Further, input interface 301 may comprise a memory (not illustrated) for storing preferences (or user profile information) affecting the available content, which can be conveyed to the information appliance device 107. Input interface 301 may support any type of wired and/or wireless link, e.g., infrared, radio frequency (RF), BLUETOOTH, and the like. Input interface 301, communication interface 317, and/or control device 303 may further comprise automatic speech recognition (ASR) and/or text-to-speech (TTS) technology for effectuating voice recognition functionality.

It is noted that the described authentication process, according to certain embodiments, can be provided as a managed service via service provider network 125, as next explained.

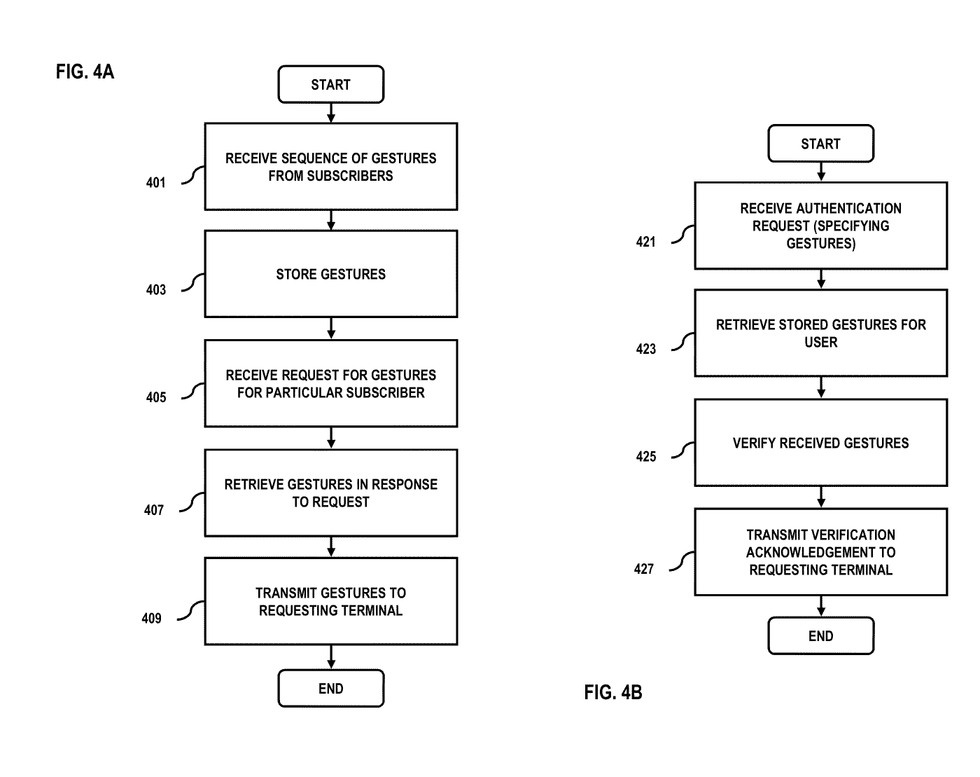

FIGS. 4A and 4B are flowcharts of processes for providing authentication services, according to an exemplary embodiment. Under this scenario, multiple users can subscribe to an authentication service. As such, in steps 401 and 403, passcodes (as specified in a sequence of gestures) are received by the authentication platform 119 from the subscribers, and stored within the user profile database 121. Subsequently, an application or process requests the gesture or sequence of gestures for a particular subscriber, as in step 405, from the authentication platform 119. For instance, the application can be executed by a point-of-sale terminal 109 upon a user attempting to make a purchase. In step 407, the platform 119 examines the request and extracts a user ID and locates the gestures for the specified user from the database 121. Next, in step 409, the authentication platform 119 sends the retrieved gestures to the requesting terminal 109. Thereafter, the terminal 109 can authenticate the user based on the gestures supplied from the authentication platform 119.

In addition to or in the alternative, the authentication process itself can be performed by the platform 119. Under this scenario, the terminal 109 does not perform the verification of the user itself, but merely supplies the gestures to the platform 119. As seen in FIG. 4B, the platform 119 receives an authentication request, which includes the user specified gestures and recognition information for the user, per step 421. The platform 119 then retrieves the stored gestures for the particular user in database 121, as in step 423. Next, the process verifies the received gestures based on the stored gestures, and acknowledges a successful or failure of the verification to the terminal 109, per steps 425 and 427. That is, the verification is successful if the supplied user gestures match the stored gestures. Furthermore, the processes of FIGS. 4A and 4B can both be implemented at the authentication platform 119.

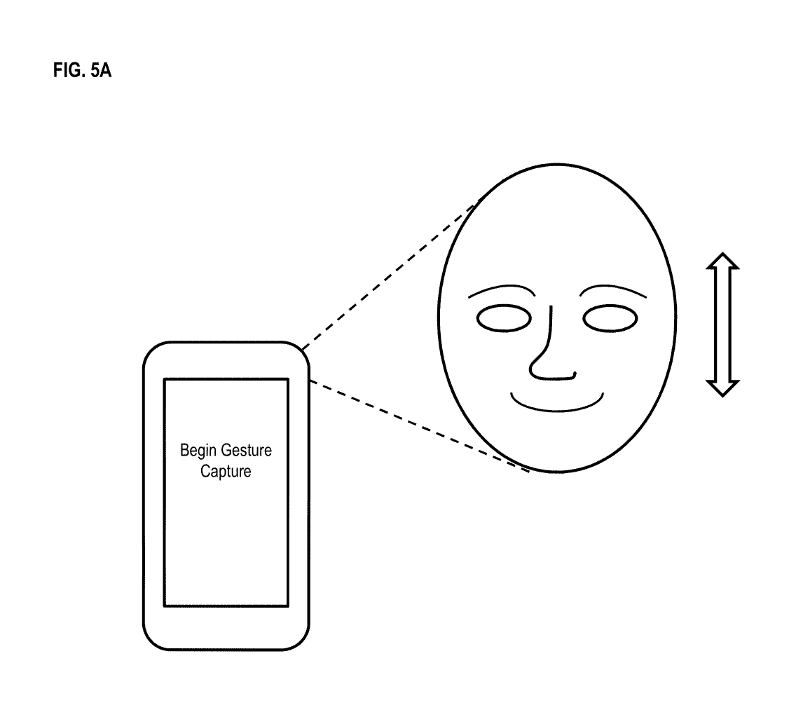

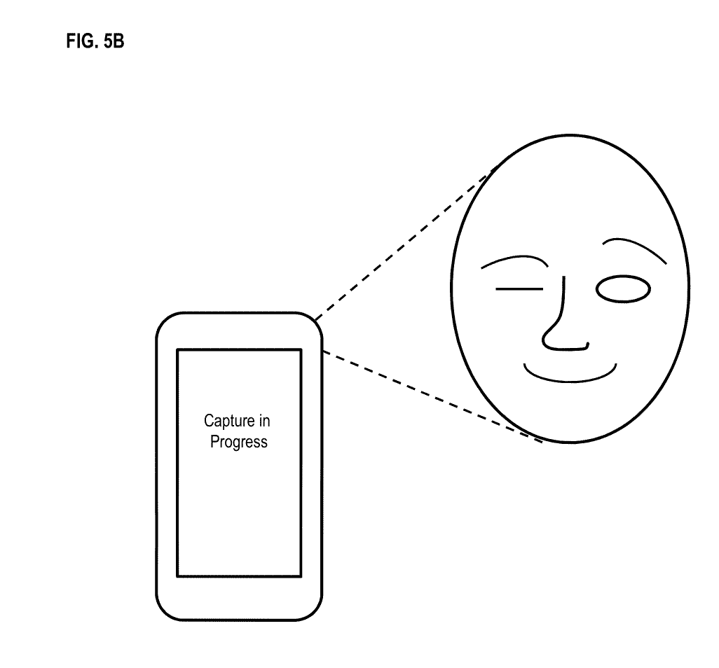

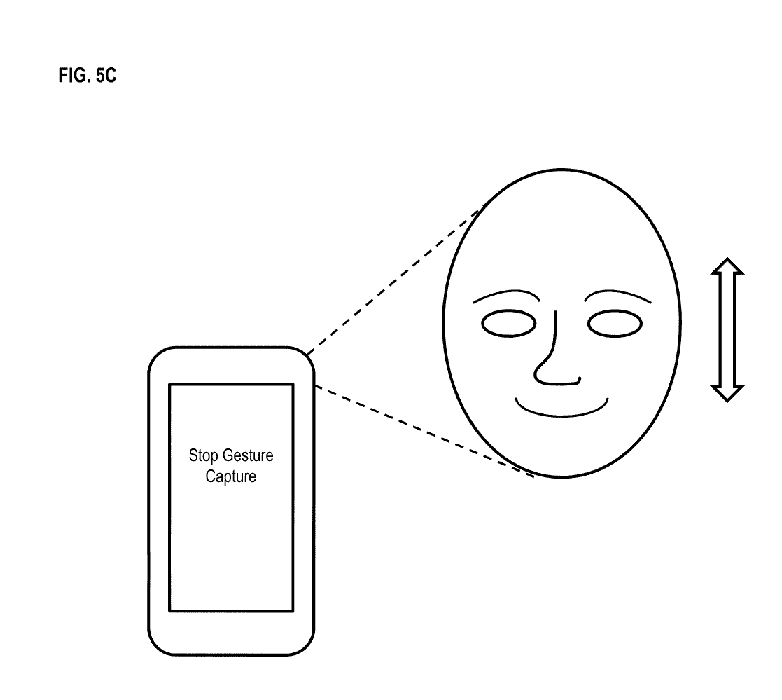

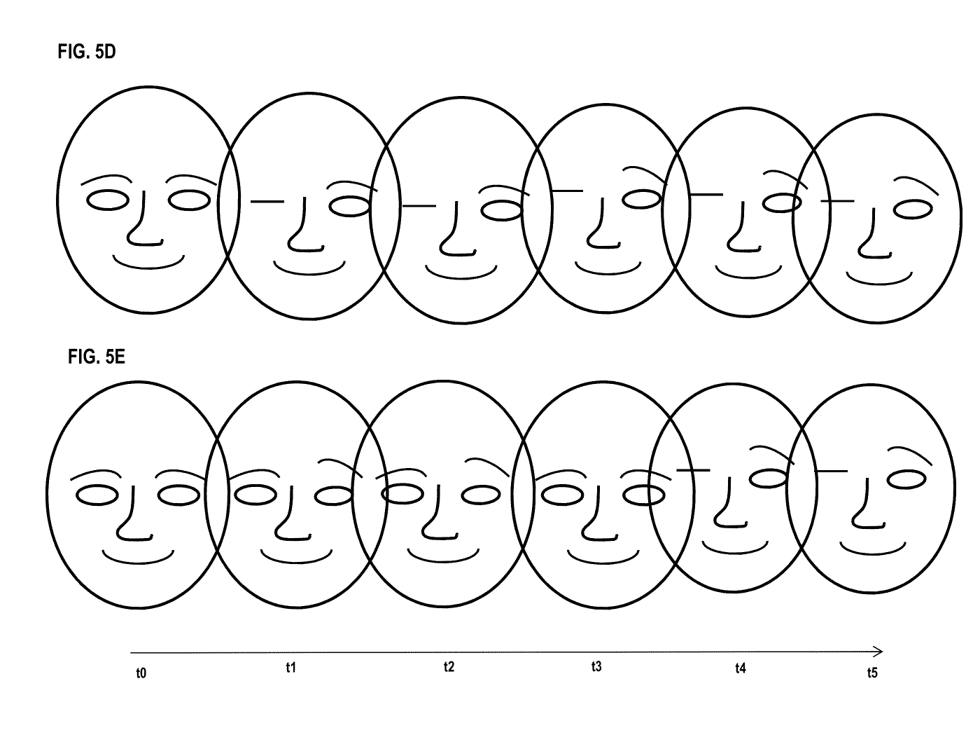

FIGS. 5A-5C are graphical user interfaces (GUIs) for capturing sequences of gestures for authentication and/or identification, according to various embodiments. As shown in FIGS. 5A-5C, in one example use case, a user enters the device's (e.g., mobile device 105 of system 100) camera view to capture an image or video. For example, the video can be in a format, e.g., Moving Picture Experts Group (MPEG) formats (e.g., MPEG-2 Audio Layer III (MP3)), Windows® media formats (e.g., Windows® Media Video (WMV)), Audio Video Interleave (AVI) format, as well as new and/or proprietary formats.

As the device 105 is secured, the device begins scanning the facial patterns of the users for recognition and identification of the user via their facial features. Next, the platform 119 may seek out the recognized face to make a series of gestures or movements that can include a start gesture, dataset gesture, a stop gesture, etc. In this case, the user nods to indicate a start gesture to initiate a gesture recognition session. The user then begins making his facial gestures (e.g., blinks and lifts eyebrow) and then concludes the gesture recognition session by performing a second nod to indicate a stop gesture. The captured images and facial maneuvers may be parsed into a recognition sequence (e.g., using an application resident at the device 105). The sequence is passed to the authentication platform 119 and/or to the authentication module 305, and the combination of the facial identity and gestures are used to authenticate the users in a multi-factor manner.

FIGS. 5D-5E show facial videos of users corresponding to the same facial gesture combination for authentication and/or identification, according to various embodiments. By way of example, the facial gesture combination of “closing one eye and raising one eyebrow,” may be executed and interpreted differently across different users depending on the users' habits and preferences. For instance, such gesture sequence can be interpreted as “closing one eye and raising one eyebrow concurrently,” “closing one eye then raising one eyebrow,” “raising one eyebrow and then closing one eye,” etc. Considering the timing factor, it can be further interpreted as “closing one eye for 20 seconds (t0-t2) and then raising one eyebrow for 30 seconds (t2-t5) continuously (FIG. 5D),” “raising one eyebrow for 20 seconds (t0-t2), back to a neutral expression for 10 seconds (t2-t3), and then raising one eyebrow and closing the other eye for 20 seconds (t3-t5) (FIG. 5E), etc. The user interpretation may be a result of reflexes, muscle memory, subconscious reactions, conscious decisions, or a combination thereof, of each individual user. The platform 119 may record the unique interpretation for each user in one or more external and/or internal databases for authentication and/or identification.

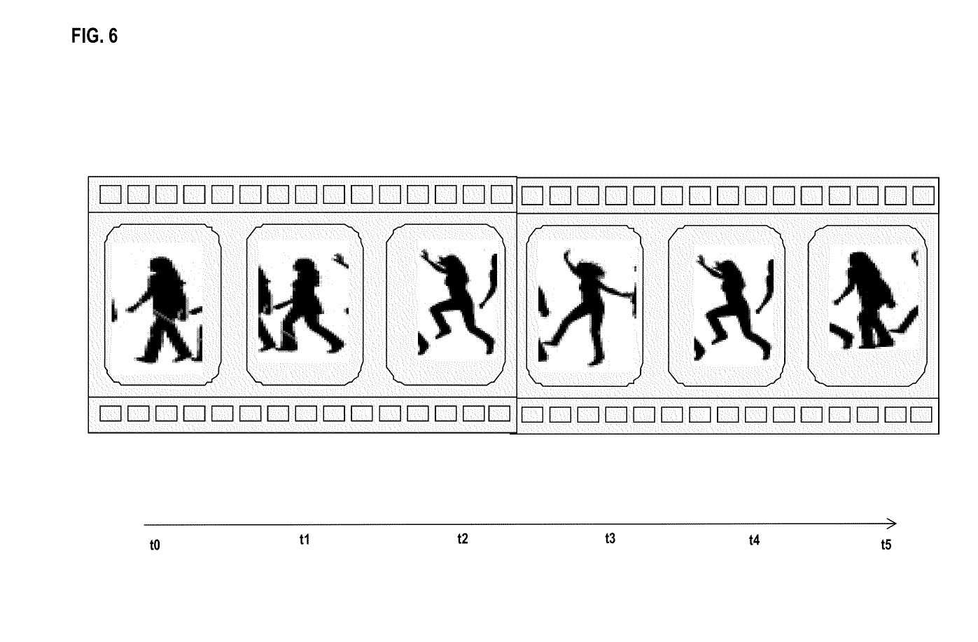

FIG. 6 shows a video corresponding to a sequence of body movement gestures for authentication and/or identification, according to one embodiment. Again, each user may interpret a gesture combination of “stepping up and jumping” differently based on user habits and preferences. By way of example, one user the gesture combination “stepping the left leg forwards for 10 seconds (t0-t1), stepping the right leg forwards and springing up for 20 seconds (t1-t2), lending with the left leg (t2-t3), using the left leg as support and jumping right up (t3-t4) and then lending with both legs on the ground (t4-t5).” The platform 119 according captures the unique interpretation for each user in one or more external and/or internal databases for authentication and/or identification.

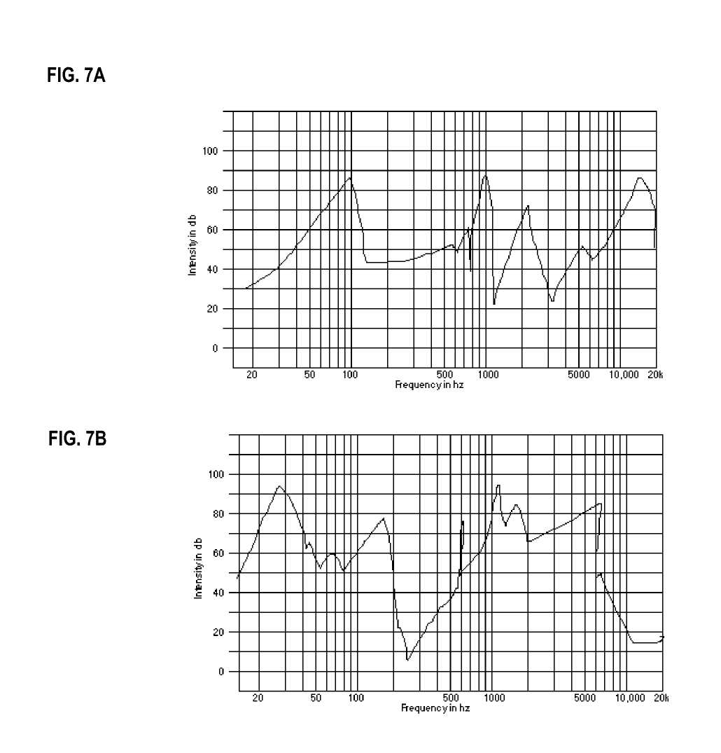

FIGS. 7A and 7B illustrate frequency charts of two users corresponding to the same sound/voice gesture combination for authentication and/or identification, according to various embodiments. In this example, two users interpret a sound gesture combination of “coughing and clearing the throat” differently based on user habits and preferences.

As another example, users respond to an authentication maneuver of “answering a phone call” with different greetings in different tones, such as “Hello, this is Mary . . . ,” “Yes, what can I do for you . . . ” etc. The platform 119 conducts speech recognition for the spoken words (i.e., what was said) and voice recognition for analyzing the person's specific voice and tone to refine the user recognition (i.e., who said it). Referring back to the example of “humming two folk songs,” the system 119 further performs song recognition (i.e., which song was sung) by analyzing the tempo, beat, bar, key, rhythm, pitch chords, a dominant melody, a bass line, etc., to refine the user recognition (i.e., who sung it). This unique interpretation may be recorded in one or more external and/or internal databases for authentication and/or identification.

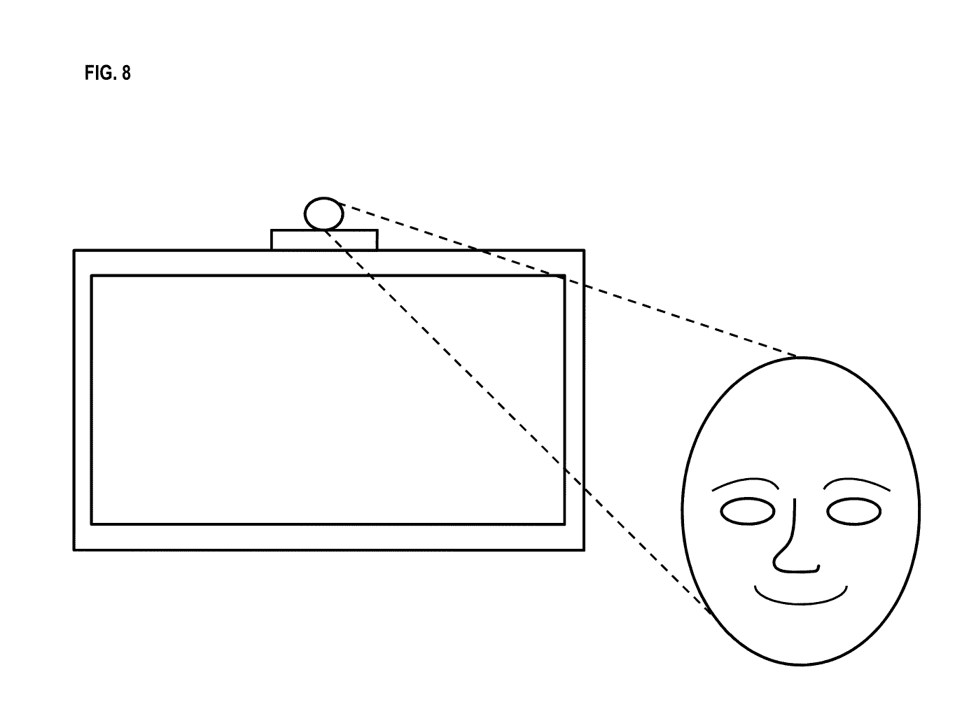

FIG. 8 is a graphical user interface for capturing sequences of gestures for authentication and/or identification, according to an exemplary embodiment. More specifically, FIG. 8 illustrates a use case in which a user has learned that he subconsciously repeats certain facial expressions or gestures while at work. The user stores these gestures or expressions as an authentication token in the authentication platform 119. Accordingly, when at work in his office, even without direct interaction at the keyboard, the user's device screensaver lock is not activated because the device regularly or continuously recognizes the user's presence via the stored gesture or expression.

The above-described embodiments of authentication platform 119 include a repository and a processing system used to conform identity using factors/processes (static gesture features, the gesture occurring processes, transitions/interfaces in-between gestures, etc.) and combinations of factors/processes to determine identity with high probability. Moreover, platform 119 is capable of storing, processing, and managing authentication gesture records, imprints, and sequences, and prompting for additional requests to further increase the accuracy of identification.

The processes described herein for providing user authentication may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

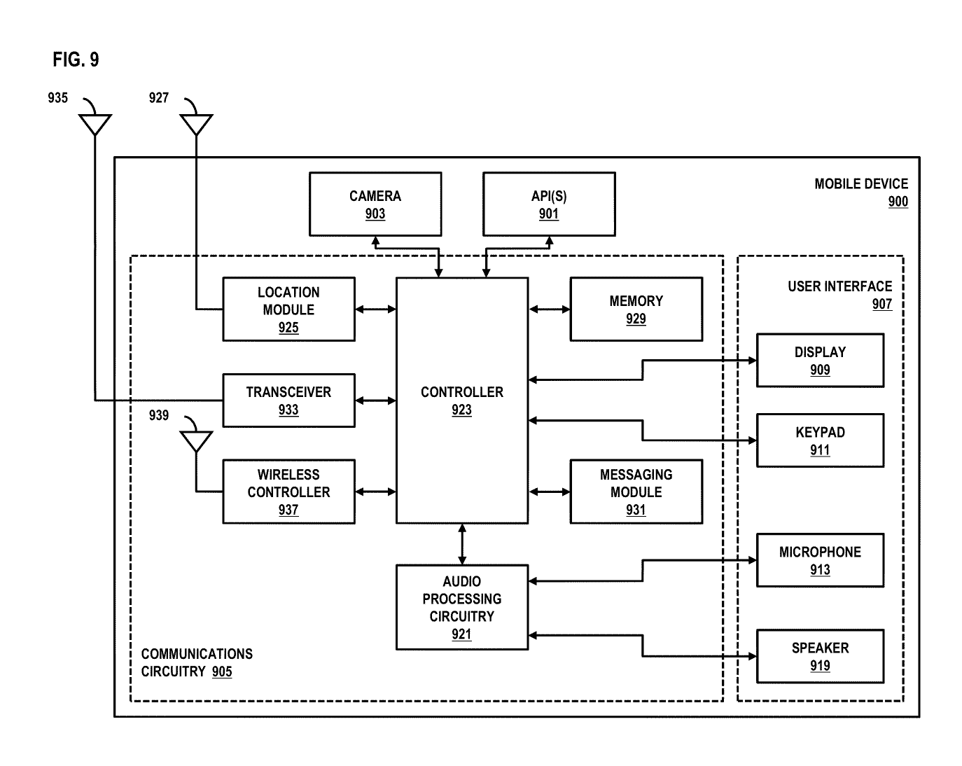

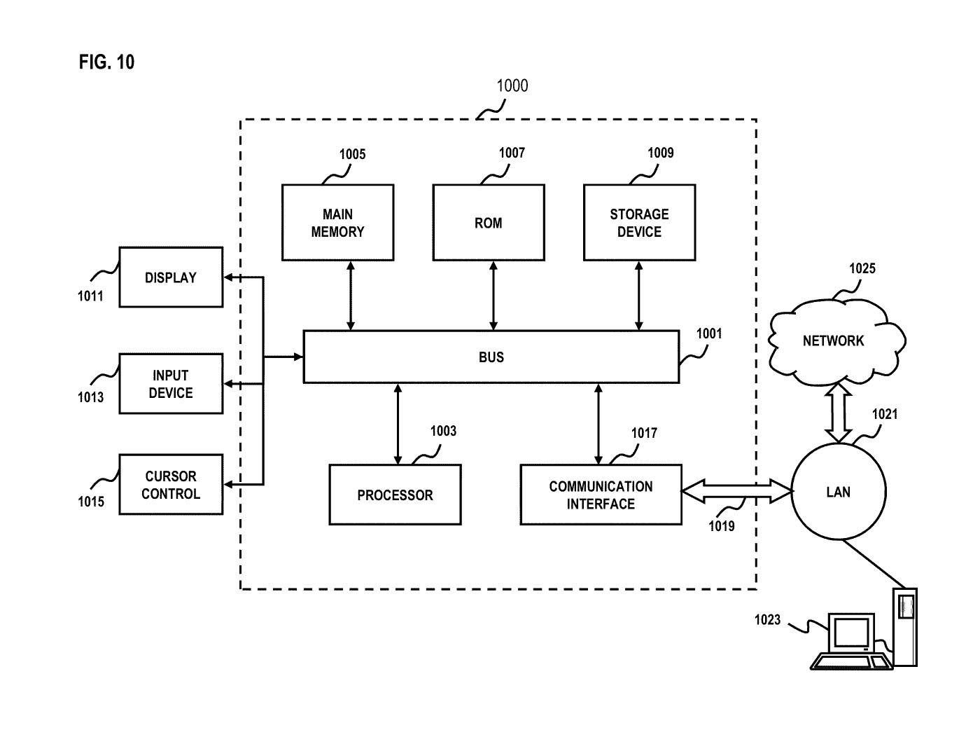

FIG. 9 is a diagram of a mobile device configured to authenticate and/or identify a user, according to an exemplary embodiment. Mobile device 900 may comprise computing hardware (such as described with respect to FIG. 10), as well as include one or more components configured to execute the processes described herein for user authentication and/or identification over a network from or through the mobile device 900. In this example, mobile device 900 includes application programming interface(s) 901, camera 903, communications circuitry 905, and user interface 907. While specific reference will be made hereto, it is contemplated that mobile device 900 may embody many forms and include multiple and/or alternative components.

According to exemplary embodiments, user interface 905 may include one or more displays 909, keypads 911, microphones 913, and/or speakers 915. Display 909 provides a graphical user interface (GUI) that permits a user of mobile device 900 to view dialed digits, call status, menu options, and other service information. The GUI may include icons and menus, as well as other text and symbols. Keypad 909 includes an alphanumeric keypad and may represent other input controls, such as one or more button controls, dials, joysticks, touch panels, etc. The user thus can construct customer profiles, enter commands, initialize applications, input remote addresses, select options from menu systems, and the like. Microphone 911 coverts spoken utterances of a user (or other auditory sounds, e.g., environmental sounds) into electronic audio signals, whereas speaker 919 converts audio signals into audible sounds.

Communications circuitry 905 may include audio processing circuitry 921, controller 923, location module 925 (such as a GPS receiver) coupled to antenna 927, memory 929, messaging module 931, transceiver 933 coupled to antenna 935, and wireless controller 937 coupled to antenna 939. Memory 929 may represent a hierarchy of memory, which may include both random access memory (RAM) and read-only memory (ROM). Computer program instructions and corresponding data for operation can be stored in non-volatile memory, such as erasable programmable read-only memory (EPROM), electrically erasable programmable read-only memory (EEPROM), and/or flash memory. Memory 929 may be implemented as one or more discrete devices, stacked devices, or integrated with controller 923. Memory 929 may store information, such as one or more customer profiles, one or more user defined policies, one or more contact lists, personal information, sensitive information, work related information, etc.

Additionally, it is contemplated that mobile device 900 may also include one or more applications and, thereby, may store (via memory 929) data associated with these applications for providing users with browsing functions, business functions, calendar functions, communication functions, contact managing functions, data editing (e.g., database, word processing, spreadsheets, etc.) functions, financial functions, gaming functions, imaging functions, messaging (e.g., electronic mail, IM, MMS, SMS, etc.) functions, multimedia functions, service functions, storage functions, synchronization functions, task managing functions, querying functions, and the like. As such, control signals received by mobile device 900 from, for example, network 117 may be utilized by API(s) 901 and/or controller 923 to facilitate remotely configuring, modifying, and/or utilizing one or more features, options, settings, etc., of these applications. It is also contemplated that these (or other) control signals may be utilized by controller 923 to facilitate remotely backing up and/or erasing data associated with these applications. In other instances, the control signals may cause mobile device 900 to become completely or partially deactivated or otherwise inoperable.

Accordingly, controller 923 controls the operation of mobile station 900, such as in response to commands received from API(s) 901 and/or data stored to memory 929. Control functions may be implemented in a single controller or via multiple controllers. Suitable controllers 923 may include, for example, both general purpose and special purpose controllers and digital signal processors. Controller 923 may interface with audio processing circuitry 921, which provides basic analog output signals to speaker 919 and receives analog audio inputs from microphone 913. In exemplary embodiments, controller 923 may be controlled by API(s) 901 in order to capture signals from camera 903 or microphone 913 in response to control signals received from network 117. In other instances, controller 923 may be controlled by API(s) 901 to cause location module 925 to determine spatial positioning information corresponding to a location of mobile device 900. Still further, controller 923 may be controlled by API(s) 901 to image (e.g., backup) and/or erase memory 929, to configure (or reconfigure) functions of mobile device 900, to track and generate device usage logs, or to terminate services available to mobile device 900. It is noted that captured signals, device usage logs, memory images, spatial positioning information, and the like, may be transmitted to network 117 via transceiver 933 and/or wireless controller 937. In this manner, the captured signals and/or other forms of information may be presented to users and stored to one or more networked storage locations, such as customer profiles repository (not shown), or any other suitable storage location or memory of (or accessible to) the components and facilities of system 100.

It is noted that real time spatial positioning information may be obtained or determined via location module 925 using, for instance, satellite positioning system technology, such as GPS technology. In this way, location module 925 can behave as (or substantially similar to) a GPS receiver. Thus, mobile device 900 employs location module 925 to communicate with constellation of satellites. These satellites transmit very low power interference and jamming resistant signals received by GPS receivers 925 via, for example, antennas 927. At any point on Earth, GPS receiver 925 can receive signals from multiple satellites, such as six to eleven. Specifically, GPS receiver 925 may determine three-dimensional geographic location (or spatial positioning information) from signals obtained from at least four satellites. Measurements from strategically positioned satellite tracking and monitoring stations are incorporated into orbital models for each satellite to compute precise orbital or clock data. Accordingly, GPS signals may be transmitted over two spread spectrum microwave carrier signals that can be shared by GPS satellites. Thus, if mobile device 900 is able to identify signals from at least four satellites, receivers 925 may decode the ephemeris and clock data, determine the pseudo range for each satellite 125 and, thereby, compute the spatial positioning of a receiving antenna 927. With GPS technology, mobile device 900 can determine its spatial position with great accuracy and convenience. It is contemplated, however, that location module 925 may utilize one or more other location determination technologies, such as advanced forward link triangulation (AFLT), angle of arrival (AOA), assisted GPS (A-GPS), cell identification (cell ID), observed time difference of arrival (OTDOA), enhanced observed time of difference (E-OTD), enhanced forward link trilateration (EFLT), network multipath analysis, and the like.

Mobile device 900 also includes messaging module 931 that is configured to receive, transmit, and/or process messages (e.g., EMS messages, SMS messages, MMS messages, IM messages, electronic mail messages, and/or any other suitable message) received from (or transmitted to) network 117 or any other suitable component or facility of system 100. As previously mentioned, network 117 may transmit control singles to mobile device 900 in the form of one or more API 901 directed messages, e.g., one or more BREW directed SMS messages. As such, messaging module 931 may be configured to identify such messages, as well as activate API(s) 901, in response thereto. Furthermore, messaging module 931 may be further configured to parse control signals from these messages and, thereby, port parsed control signals to corresponding components of mobile device 900, such as API(s) 901, controller 923, location module 925, memory 929, transceiver 933, wireless controller 937, etc., for implementation.

According to exemplary embodiments, API(s) 901 (once activated) is configured to effectuate the implementation of the control signals received from network. It is noted that the control signals are utilized by API(s) 901 to, for instance, remotely control, configure, monitor, track, and/or capture signals from (or related to) camera 903, communications circuitry 905, and/or user interface 907. In this manner, visual and/or acoustic indicia pertaining to an environment surrounding mobile device 900 may captured by API(s) 901 controlling camera 903 and microphone 913. Other control signals to cause mobile device 900 to determine spatial positioning information, to image and/or erase memory 929, to configure (or reconfigure) functions, to track and generate device usage logs, or to terminate services, may also be carried out via API(s) 901. As such, one or more signals captured from camera 903 or microphone 913, or device usage logs, memory images, spatial positioning information, etc., may be transmitted to network 117 via transceiver 933 and/or wireless controller 937, in response to corresponding control signals provided to transceiver 933 and/or wireless controller 937 by API(s) 901. Thus, captured signals and/or one or more other forms of information provided to network 117 may be presented to users and/or stored to one or more of customer profiles repository (not shown), or any other suitable storage location or memory of (or accessible to) the components and facilities of system 100.

It is also noted that mobile device 900 can be equipped with wireless controller 937 to communicate with a wireless headset (not shown) or other wireless network. The headset can employ any number of standard radio technologies to communicate with wireless controller 937; for example, the headset can be BLUETOOTH enabled. It is contemplated that other equivalent short range radio technology and protocols can be utilized. While mobile device 900 has been described in accordance with the depicted embodiment of FIG. 9, it is contemplated that mobile device 900 may embody many forms and include multiple and/or alternative components.

The described processes and arrangement advantageously enables user authentication and/or identification over a network. The processes described herein for user authentication and/or identification may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 10 illustrates computing hardware (e.g., a computer system) upon which an embodiment according to the invention can be implemented to authenticate and/or identify a user over a network. The computer system 1000 includes a bus 1001 or other communication mechanism for communicating information and a processor 1003 coupled to the bus 1001 for processing information. The computer system 1000 also includes a main memory 1005, such as random access memory (RAM) or other dynamic storage device, coupled to the bus 1001 for storing information and instructions to be executed by the processor 1003. The main memory 1005 also can be used for storing temporary variables or other intermediate information during execution of instructions by the processor 1003. The computer system 1000 may further include a read only memory (ROM) 1007 or other static storage device coupled to the bus 1001 for storing static information and instructions for the processor 1003. A storage device 1009, such as a magnetic disk or optical disk, is coupled to the bus 1001 for persistently storing information and instructions.

The computer system 1000 may be coupled via the bus 1001 to a display 1011, such as a cathode ray tube (CRT), liquid crystal display, active matrix display, or plasma display, for displaying information to a computer user. An input device 1013, such as a keyboard including alphanumeric and other keys, is coupled to the bus 1001 for communicating information and command selections to the processor 1003. Another type of user input device is a cursor control 1015, such as a mouse, a trackball, or cursor direction keys, for communicating direction information and command selections to the processor 1003 and for controlling cursor movement on the display 1011.

According to an embodiment of the invention, the processes described herein are performed by the computer system 1000, in response to the processor 1003 executing an arrangement of instructions contained in the main memory 1005. Such instructions can be read into the main memory 1005 from another computer-readable medium, such as the storage device 1009. Execution of the arrangement of instructions contained in the main memory 1005 causes the processor 1003 to perform the process steps described herein. One or more processors in a multi-processing arrangement may also be employed to execute the instructions contained in the main memory 1005. In alternative embodiments, hard-wired circuitry may be used in place of or in combination with software instructions to implement the embodiment of the invention. Thus, embodiments of the invention are not limited to any specific combination of hardware circuitry and software.

The computer system 1000 also includes a communication interface 1017 coupled to bus 1001. The communication interface 1017 provides a two-way data communication coupling to a network link 1019 connected to a local network 1021. For example, the communication interface 1017 may be a digital subscriber line (DSL) card or modem, an integrated services digital network (ISDN) card, a cable modem, a telephone modem, or any other communication interface to provide a data communication connection to a corresponding type of communication line. As another example, the communication interface 1017 may be a local area network (LAN) card (e.g. For Ethernet™ or an Asynchronous Transfer Mode (ATM) network) to provide a data communication connection to a compatible LAN. Wireless links can also be implemented. In any such implementation, the communication interface 1017 sends and receives electrical, electromagnetic, or optical signals that carry digital data streams representing various types of information. Further, the communication interface 1017 can include peripheral interface devices, such as a Universal Serial Bus (USB) interface, a PCMCIA (Personal Computer Memory Card International Association) interface, etc. Although a single communication interface 1017 is depicted in FIG. 9, multiple communication interfaces can also be employed.

The network link 1019 typically provides data communication through one or more networks to other data devices. For example, the network link 1019 may provide a connection through a local network 1021 to a host computer 1023, which has connectivity to a network 1025 (e.g. A wide area network (WAN) or the global packet data communication network now commonly referred to as the “Internet”) or to data equipment operated by a service provider. The local network 1021 and the network 1025 both use electrical, electromagnetic, or optical signals to convey information and instructions. The signals through the various networks and the signals on the network link 1019 and through the communication interface 1017, which communicate digital data with the computer system 1000, are exemplary forms of carrier waves bearing the information and instructions.

The computer system 1000 can send messages and receive data, including program code, through the network(s), the network link 1019, and the communication interface 1017. In the Internet example, a server (not shown) might transmit requested code belonging to an application program for implementing an embodiment of the invention through the network 1025, the local network 1021 and the communication interface 1017. The processor 1003 may execute the transmitted code while being received and/or store the code in the storage device 1009, or other non-volatile storage for later execution. In this manner, the computer system 1000 may obtain application code in the form of a carrier wave.

The term “computer-readable medium” as used herein refers to any medium that participates in providing instructions to the processor 1003 for execution. Such a medium may take many forms, including but not limited to non-volatile media, volatile media, and transmission media. Non-volatile media include, for example, optical or magnetic disks, such as the storage device 1009. Volatile media include dynamic memory, such as the main memory 1005. Transmission media include coaxial cables, copper wire and fiber optics, including the wires that comprise the bus 1001. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

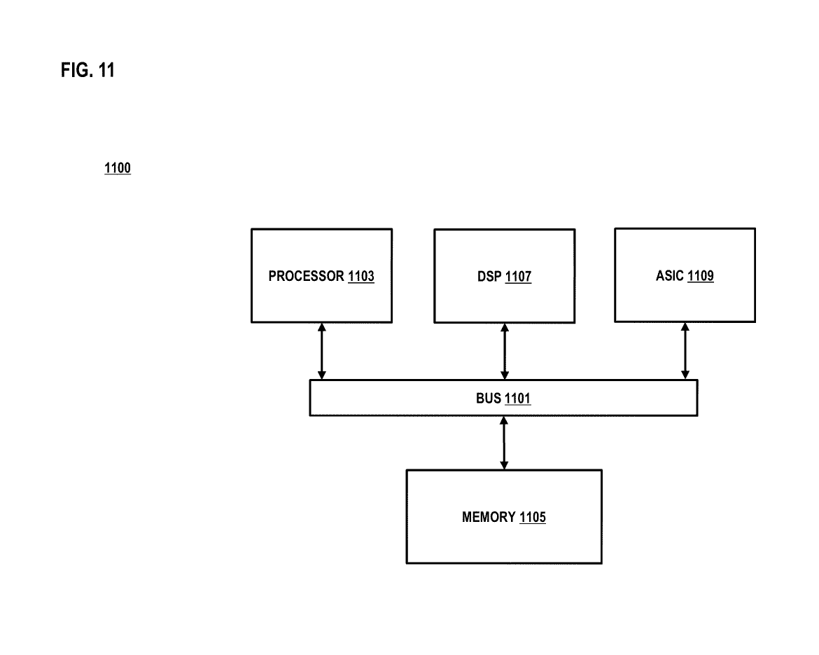

FIG. 11 illustrates a chip set 1100 upon which an embodiment of the invention may be implemented. The chip set 1100 is programmed to authenticate and/or identify a user as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. The chip set 1100, or a portion thereof, constitutes a means for performing one or more steps of FIGS. 3-5.

In one embodiment, the chip set 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set top box based on device events. The memory 1105 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
capturing a plurality of media data sets of a user performing a sequence of gestures;
analyzing the plurality of media data sets to determine the sequence of gestures; and
authenticating the user based on the sequence of gestures.

2. A method of claim 1, wherein the sequence of gestures include body movement gestures, voice gesture, sound gestures, or a combination thereof.

3. A method of claim 2, further comprising:
analyzing the plurality of media data sets to determine one or more features of each of the gestures, one or more features of the sequence of gestures, or a combination thereof;
recognizing the user based on the features of each of the gestures, the features of the sequence of gestures, or a combination thereof,
wherein the features include content information, timing information, ranging information, or a combination thereof, and the authenticating of the user is further based on the recognition.

4. A method of claim 3, wherein the timing information includes a start time, a stop time, an overlapping period, an interval, or a combination thereof, of the sequence of gestures.

5. A method of claim 3, further comprising:
comparing the features associated with the sequence of gestures against features of one or more pre-stored sequences,
wherein the recognition of the user is based on the comparison.

6. A method of claim 3, further comprising:
determining one or more access policies for at least one resource;
applying one or more of the access policies based, at least in part, upon the authenticating of the user; and
causing, at least in part, operation of at least one action with respect to the at least one resource based upon the applied one or more access policies.

7. A method of claim 6, further comprising:
determining context of the authenticating of the user; and
selecting among the features of each of the gestures, the features of the sequence of gestures, or a combination thereof for recognizing the user, based, at least in part, on the context of the authenticating of the user, the applied one or more access policies, or a combination thereof.

8. An apparatus comprising:
at least one processor; and
at least one memory including computer program code for one or more programs,
the at least one memory and the computer program code configured to, with the at least one processor, cause the apparatus to perform at least the following,
capture a plurality of media data sets of a user performing a sequence of gestures, analyze the plurality of media data sets to determine the sequence of gestures, and authenticate the user based on the sequence of gestures.

9. An apparatus of claim 8, wherein the sequence of gestures include body movement gestures, voice gesture, sound gestures, or a combination thereof.

10. An apparatus of claim 9, wherein the apparatus is further caused to:
analyze the plurality of media data sets to determine one or more features of each of the gestures, one or more features of the sequence of gestures, or a combination thereof;
recognize the user based on the features of each of the gestures, the features of the sequence of gestures, or a combination thereof,
wherein the features include content information, timing information, ranging information, or a combination thereof, and the authenticating of the user is further based on the recognition.

11. An apparatus of claim 10, wherein the timing information includes a start time, a stop time, an overlapping period, an interval, or a combination thereof, of the sequence of gestures.

12. An apparatus of claim 10, wherein the apparatus is further caused to:
compare the features associated with the sequence of gestures against features of one or more pre-stored sequences,
wherein the recognition of the user is based on the comparison.

13. An apparatus of claim 10, wherein the apparatus is further caused to:
determine one or more access policies for at least one resource;
apply one or more of the access policies based, at least in part, upon the authenticating of the user; and
cause, at least in part, operation of at least one action with respect to the at least one resource based upon the applied one or more access policies.

14. An apparatus of claim 13, wherein the apparatus is further caused to:
determine context of the authenticating of the user; and
select among the features of each of the gestures, the features of the sequence of gestures, or a combination thereof for recognizing the user, based, at least in part, on the context of the authenticating of the user, the applied one or more access policies, or a combination thereof.

15. A system comprising:
a computing device configured to,
analyze a plurality of media data sets to determine a sequence of gestures captured by a user device; and
authenticate the user based on the sequence of gestures.

16. A system of claim 15, wherein the sequence of gestures include body movement gestures, voice gesture, sound gestures, or a combination thereof.

17. A system of claim 16, wherein the computing device is further configured to:
analyze the plurality of media data sets to determine one or more features of each of the gestures, one or more features of the sequence of gestures, or a combination thereof;
recognize the user based on the features of each of the gestures, the features of the sequence of gestures, or a combination thereof,
wherein the features include content information, timing information, ranging information, or a combination thereof, and the authenticating of the user is further based on the recognition.

18. A system of claim 17, wherein the timing information includes a start time, a stop time, an overlapping period, an interval, or a combination thereof, of the sequence of gestures.

19. A system of claim 17, wherein the server is further configured to:
compare the features associated with the sequence of gestures against features of one or more pre-stored sequences,
wherein the recognition of the user is based on the comparison.

20. A system of claim 17, wherein the computing device is further configured to:
determine one or more access policies for at least one resource;
apply one or more of the access policies based, at least in part, upon the authenticating of the user; and
cause, at least in part, operation of at least one action with respect to the at least one resource based upon the applied one or more access policies.
